(19) United States
(12) Patent Application Publication
(10) Pub. No.: US 2002/0133395 A1
(43) Pub. Date: Sep. 19, 2002

(54) Technical standard review and approval

(76) Inventors: John Ronald Hughes, Cincinnati, OH (US); Steven Charles Tullis, Redmond, WA (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/808,001

(22) Filed: Mar. 14, 2001

Related U.S. Application Data
(60) Provisional application No. 60/256,838, filed on Dec. 19, 2000.

(51) Int. Cl. G06F 17/60

(52) U.S. Cl. 705/11; 705/7; 705/1

(57) ABSTRACT

Automated electronic review and approval of technical standards assists in product development. A draft technical standard is generated and electronically circulated to a review group. Review group comments are automatically attached to the draft technical standard. The draft technical standard is electronically locked before circulation to an approval group. The approval group members have access to comments of the review group members. Electronic approvals are collected from each member of the review group. Once each member of the review group has electronically approved the standard, the standard is rendered unchangeable. The standard is then released for global electronic access to a global database.

### CROSS-REFERENCE TO RELATED APPLICATIONS

This application claims the benefit of U.S. provisional application Serial No. 60/256,838 filed Dec. 19, 2000.

### BACKGROUND OF THE INVENTION

1. Field of the Invention

The present invention relates to electronically reviewing and approving technical standards resulting from the process of product development.

2. Background Art

Throughout the lifecycle of product development and manufacture, standards (sometimes called specifications) are used to communicate and record product requirements. These requirements may include raw materials, product formulation, packaging materials, product packing, test methods, and the like. Typically, each standard has its own lifecycle beginning with a draft. This draft may be created from scratch or may be formed by modifying an existing standard. Typically, the standard is then circulated for review and comments. The standard must then be approved before being released for general use.

Product manufacturers typically have procedures for developing and releasing standards. These procedures are designed to meet the requirements and guidelines of internal policies, industry standards, regulatory organizations, government rules, and the like. For a large company with a broad product line and globally-diverse manufacture, distribution and marketing responsibilities, requirements for both products and their standards may vary across regions and countries, as well as across product lines. Often, policies are implemented manually, depending entirely on human activity for timeliness and accuracy. When it is used, computer automation provides support for only portions of the standard development lifecycle. For example, document development, electronic distribution and approval status tracking are all available. However, such tools are disjointed and are often operated independently, still requiring extensive human intervention and duplication of effort in the standards development process. In addition, authority and accountability are often difficult to assign or trace. These problem may be worsened by globalization of product development, which often results in worker no longer being co-located.

What is needed is a system and method for developing technical standards for product development that fully automates and integrates the standard review and approval process. Global access should be provided for standard development. Standards and support documentation at any stage of development should be storable, searchable and archivable for historic reference. A full range of change control should also be provided. Standard development should fit current work tools such as web browsers, electronic mail, wordprocessors, and the like. The standard development process should be validated where necessary to meet the requirements of global regulatory bodies. Standards should also be kept secure from unauthorized access and modification.

### SUMMARY OF THE INVENTION

The present invention provides an integrated system for automated handling of technical standards, which may include creation, review, approval, storage distribution, and the like.

A method of developing a technical standard in the process of product development is provided. A draft technical standard is generated. The draft technical standard is electronically circulated to a review group. Review group comments are automatically attached to the draft technical standard. The draft technical standard is electronically locked before circulation to an approval group. The approval group members have access to comments of the review group members. Electronic approvals are collected from each member of the approve group. Once each member of the approve group has electronically approved the standard, the standard is rendered unchangeable. The standard is then released for electronic access. Thus, management of the review and approval process may be closely controllable by the originator of a technical standard change. This improves quality and speed of work in a globally-distributed environment.

In an embodiment of the present invention, generating a draft technical standard includes electronically capturing a text-based document containing information related to the draft technical standard and adding data-structured attributes to the captured document. The technical standard may be searched based on the data-structured attributes. Data-structured attributes may include code number, product name, standards type, geographical region, business name, lifecycle stage, originator, or the like.

In another embodiment of the present invention, additional documentation may be attached to the draft technical document. The additional documentation may be accessed by other users such as members of the review group or the approve group.

In other embodiments of the present invention, the status of review and approval may be electronically tracked. Specified users may be electronically notified when the electronic standard is released. The released technical standard may be stored in a globally accessible database. System or user performance diagnostics can be generated such as, for example, average transaction time for the standards of a given business, average approval time for a given approver, and the like.

In still another embodiment of the present invention, the technical standard is stored in a rendered format and a native format. If this standard is to be modified, the native format standard is modified, the version is incremented and the incremented version technical standard is circulated to the approval group.

In yet another embodiment of the present invention, the technical standard is translated into at least one language/rendition different than the language or rendition in which the technical standard was generated. The translated technical standard is linked to the generated technical standard.

In a further embodiment of the present invention, access to technical standards is limited based on user authorization. A user may be approved for authorized access by collecting at least one electronic approval. A user may also be approved for authorized access based on a role assigned to the user.

A system for managing a technical standard is also provided. The system includes a development database holding technical standards. A rendition module renders approved technical standards unchangeable. An interface module electronically circulates draft technical standards to a review group. Review group comments are automatically attached to the standard. The standard is locked and electronically circulated to members of an approval group. The interface module collects electronic approvals from each member of the approval group. The interface module then permits electronic access to the technical standard after the released approved technical standard is rendered unchangeable.

In an embodiment of the present invention, the rendered standard is available to system users in read-only form. The rendered standard can also be printed for hard copy use. Each hard copy page is automatically watermarked with a print date and GMT time so that users can determine if a printed copy is current.

In another embodiment of the present invention, the system further includes a reference database holding approved technical standards. An integration module copies approved technical standards from the development database to the reference database.

A method of specifying a product is also provided. The method includes developing at least one raw material object described by at least one technical standard. At least one product formula or design object described by at least one technical standard is also developed. Each formula object specifies raw material used in manufacturing the product. Each product formula object may be linked with any raw material object representing raw material used in the manufacture of the product. At least one packaging material object described by at least one technical standard is also developed. Each packaging material object specifies at least one element of a package used to hold the product.

In an embodiment of the present invention, the method further includes developing at least one package object described by at least one packing standard. Each package object specifies at least one finished package. The package object may be linked with any packaging material object representing packaging material specified by the packing standard. Each package object may also be linked with any formula object representing a formula specified by the packing standard.

In another embodiment of the present invention, at least one plant object is developed specifying a production plant. A plant object may be linked to any formula object specifying a product made in the plant. Each plant object may also be linked to any raw material object specifying raw material authorized to be used by the plant. Each plant object may further be linked to any packaging material object specifying packaging material authorized to be used in the plant.

In yet another object of the present invention, at least one brand object is developed specifying a commercial brand. A brand object may be linked to any formula object specifying a product sold under the commercial brand.

In still another embodiment of the present invention, at least one material group object is developed specifying a material classification. The material group object may be linked to a raw material object or packaging object specifying material in the material classification.

In still other embodiments of the present invention, each technical standard may be linked to a security group object controlling access to the technical standard, may be linked to a standards object specifying an approval lifecycle, may be linked to a language/rendition object specifying at least one language/rendition for presenting the standard, may be linked to at least one comment object including comments about the technical standard, or may be linked to at least one change request object specifying at least one technical standard which needs to be reviewed, approved and distributed.

In a further embodiment of the present invention, at least one technical standard is linked to at least one person object specifying a product development user. Each person object may be linked to at least one peer review object specifying users which may review a technical standard change request, may be linked to at least one approver object specifying at least one user which approves a technical standard change request, and may be linked to at least one distribution object specifying users to which an approved technical standard is distributed.

A system for specifying a finished package is also provided. The finished package has at least one product formula or design and at least one packaging material. The system includes a development database holding technical standards such as one or more raw material technical standards specifying raw material characteristics, one or more product formula technical standards specifying product characteristics, one or more packaging material technical standards specifying characteristics of at least one packaging material, and one or more packing standards specifying characteristics of at least one finished package. The system also includes an interface module permitting at least one specified approver user to approve a selected technical standard.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1. is a flow diagram of standard review and approval according to an embodiment of the present invention;

FIG. 2 is an illustration of electronic reviewer tools according to an embodiment of the present invention;

FIG. 3 is an illustration of electronic peer review commenting according to an embodiment of the present invention;

FIG. 4 is an illustration of electronic approver notification according to an embodiment of the present invention;

FIG. 5 is an illustration of electronic approver tools according to an embodiment of the present invention;

FIG. 6 is an illustration of electronic reviewing comments according to an embodiment of the present invention;

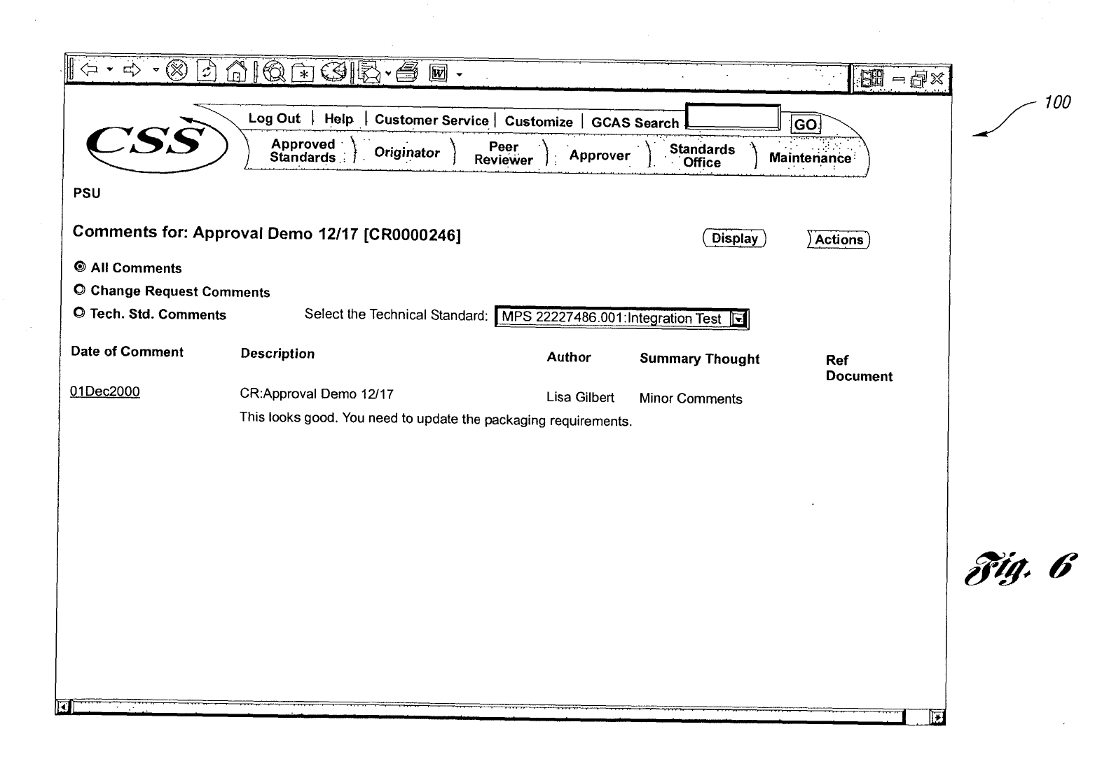

FIG. 7 is an illustration of electronic approval according to an embodiment of the present invention;

FIG. 8 is an illustration of a rendered standard according to an embodiment of the present invention;

FIG. 9 is an illustration of approval status checking according to an embodiment of the present invention;

FIG. 10 is a block diagram of a system for review, approval and distribution according to an embodiment of the present invention;

FIG. 11 is a schematic diagram of objects for specifying a product according to an embodiment of the present invention;

FIG. 12 is a block diagram of raw material standards according to an embodiment of the present invention;

FIG. 13 is a block diagram of formula standards according to an embodiment of the present invention;

FIG. 14 is a block diagram of packaging material standards according to an embodiment of the present invention;

FIG. 15 is a block diagram of packing standards according to an embodiment of the present invention;

FIG. 16 is an illustration of a packaging material specification header according to an embodiment of the present invention;

FIG. 17 is an illustration of a packaging material specification description according to an embodiment of the present invention;

FIG. 18 is an illustration of packaging material specification attribute controls according to an embodiment of the present invention;

FIG. 19 is a schematic diagram of an expanded object model according to an embodiment of the present invention;

FIG. 20 is a schematic diagram of an organizational object model according to an embodiment of the present invention;

FIG. 21 is a schematic diagram of a review, approve and distribute object model according to an embodiment of the present invention; and

FIG. 22 is an illustration of user approval according to an embodiment of the present invention.

### DETAILED DESCRIPTION OF THE PREFERRED EMBODIMENTS

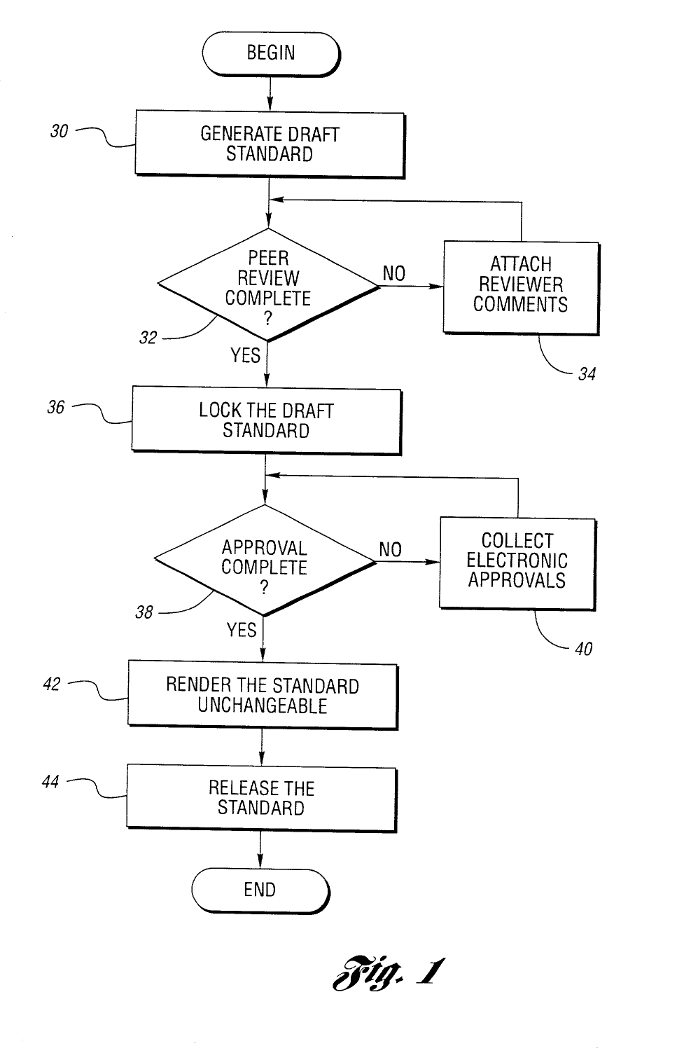

Referring to FIG. 1, a flow diagram of standard review and approval according to an embodiment of the present invention is shown. As will be appreciated by one of ordinary skill in the art, the operations illustrated in the flow diagram are not necessarily sequential operations. The order of steps may be modified within the spirit and scope of the present invention. Also, the method illustrated may be implemented by any combination of hardware, software, firmware, and the like. The present invention transcends any particular implementation and the embodiment is shown in sequential flow chart form for ease of illustration.

A draft standard is generated in block 30. Draft technical standards may be generated in a variety of ways. Initially, a text-based document containing information relating to the draft technical standard may be electronically captured such as by scanning and optical character recognition. Some or all of the draft technical standard may already exist in electronic format such as in a spreadsheet or wordprocessor document. The draft technical standard may also be generated by modifying an existing technical standard. In this case, the version of the technical standard is incremented to indicate the new draft standard. The draft standard is typically associated with a change request which may assist in tracking and routing the draft standard. A change request may pertain to one or more draft technical standards. Once the draft technical standard is generated, data-structured attributes may be added to assist in searching for the technical standard within system databases.

The draft technical standard is circulated for peer review in block 32. If peer review is desired, a group of reviewers is determined for the technical document. The technical document is automatically routed to the peer review group for examination. The peer review process is typically terminated when each reviewer has had an opportunity to comment on the draft technical standard. However, other techniques for terminating peer review are possible. For example, a time limit may be set for peer review. Also, alternate peer reviewers may be specified such that peer review will be considered complete if a selected number of reviewers from each subgroup has reviewed the draft technical standard.

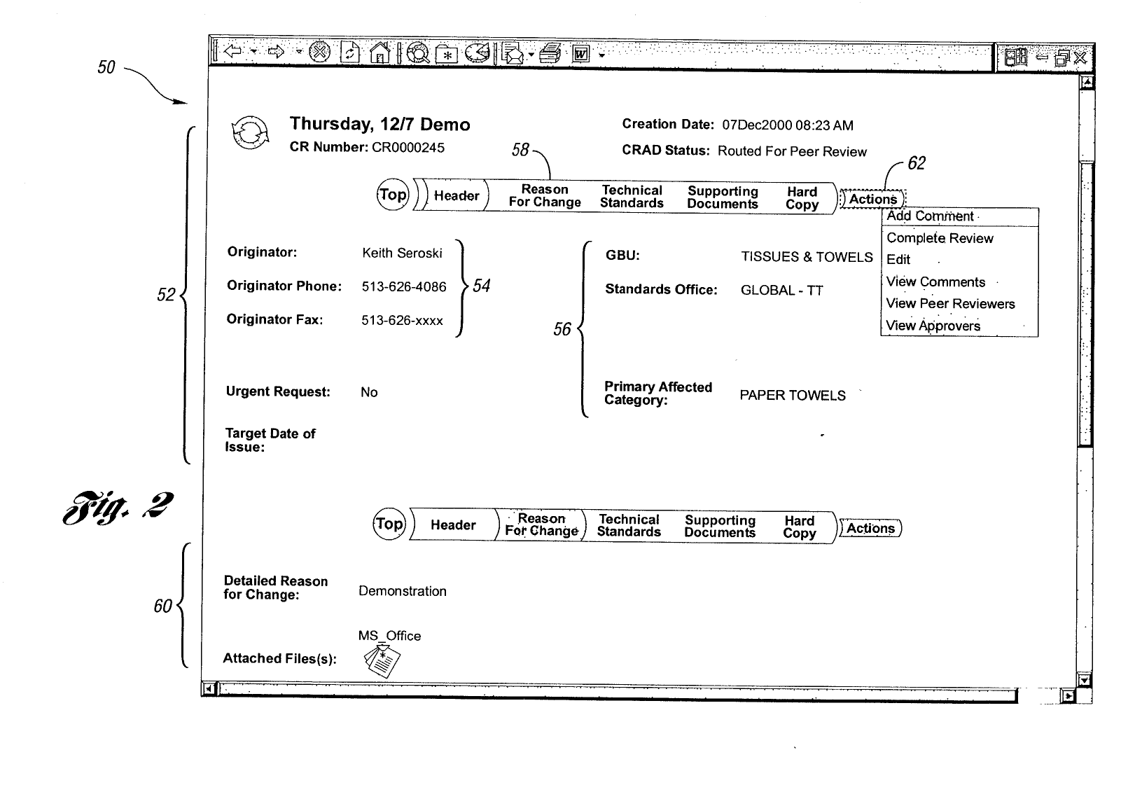

Reviewer comments are attached to the draft technical standard in block 34. Each reviewer may access review tools through a standard interface such as a web browser as depicted in FIG. 2. A reviewer screen, shown generally by 50, includes header 52. Header 52 contains originator information 54 indicating the originator who is typically the controller of the draft technical standard review and approval process. While a given standard may have one or more originators, having a single originator assigns both the right and responsibility to control change. This provides accountability and authority for standard creation and change.

Business information 56 may also be provided, such as the affected business unit (GBU), controlling standards office, affected product category, and the like. Screen control 58 provides access to review information including header 52, reason for change, technical standards and supporting documents. Reason for change area 60 allows the originator to provide a detailed reason for changing or introducing the technical standard. The originator may also attach support documentation. Action control 62 provides a list of reviewer actions including commenting, finishing the review, editing the review, viewing comments from other reviewers, viewing the list of peer reviewers and viewing the list of approvers.

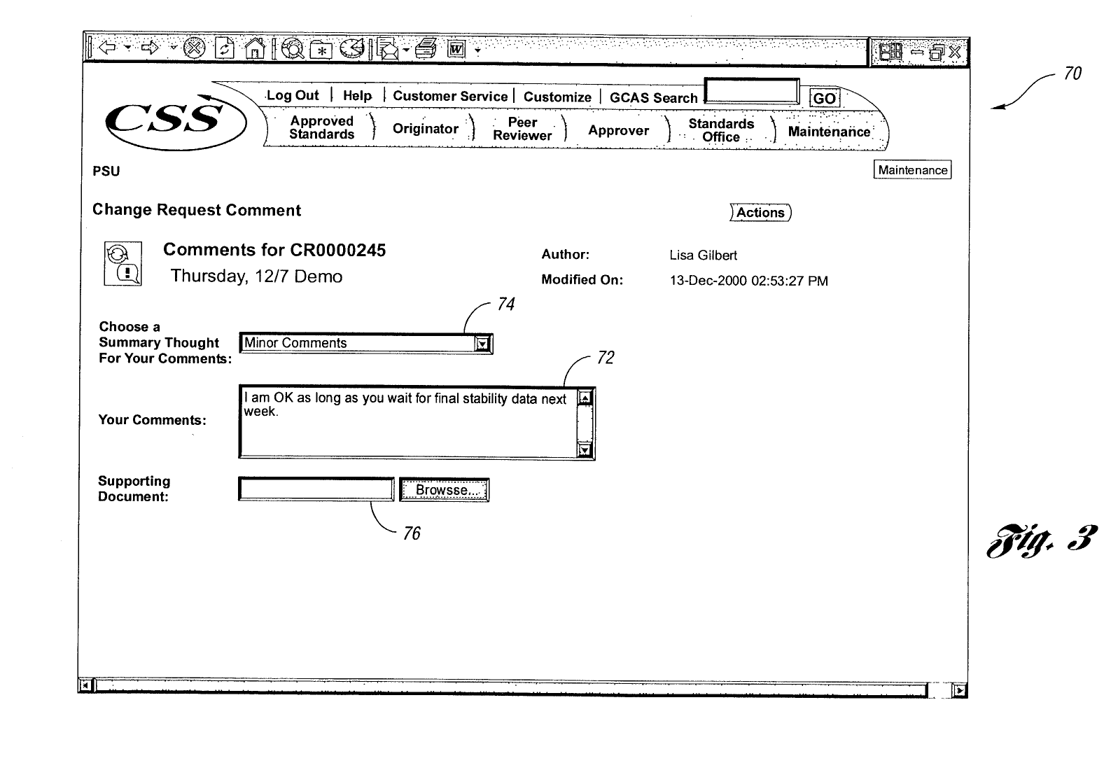

Referring now to FIG. 3, an illustration of peer review commenting according to an embodiment of the present invention is shown. A reviewer comment screen, shown generally by 70, provides an opportunity for reviewer feedback. The user may type a comment into comment text control 72. The user may also select one of a plurality of preset summaries from summary thought control 74. The reviewer may also attach additional documentation to the draft technical standard using supporting document control 76.

Referring again to FIG. 1, the draft standard is locked in blocks 36. Locking the draft technical standard prevents any additional changes to be made unless the standard is unlocked. Locking the draft technical standard prevents separate uncoordinated changes. The draft standard may be locked prior to peer review, following peer review, or during the process of peer review. The draft standard may be locked by locking the entry for the draft standard in a database holding the draft standard. Preferably, the draft standard is locked automatically based on one or more events in the process of generating and reviewing the draft standard. Limited access is provided to unlock the draft standard. Typically, the draft standard originator may unlock the draft standard. If the draft standard is unlocked, any approvals that may have occurred to that point are automatically removed.

The draft standard is electronically circulated to members of an approval group in block 38. The approval process continues until each specified member of the approval group has electronically approved the draft standard as in block 40. Approver subgroups may be used providing alternative approvers. Substitute approvers may also be designated.

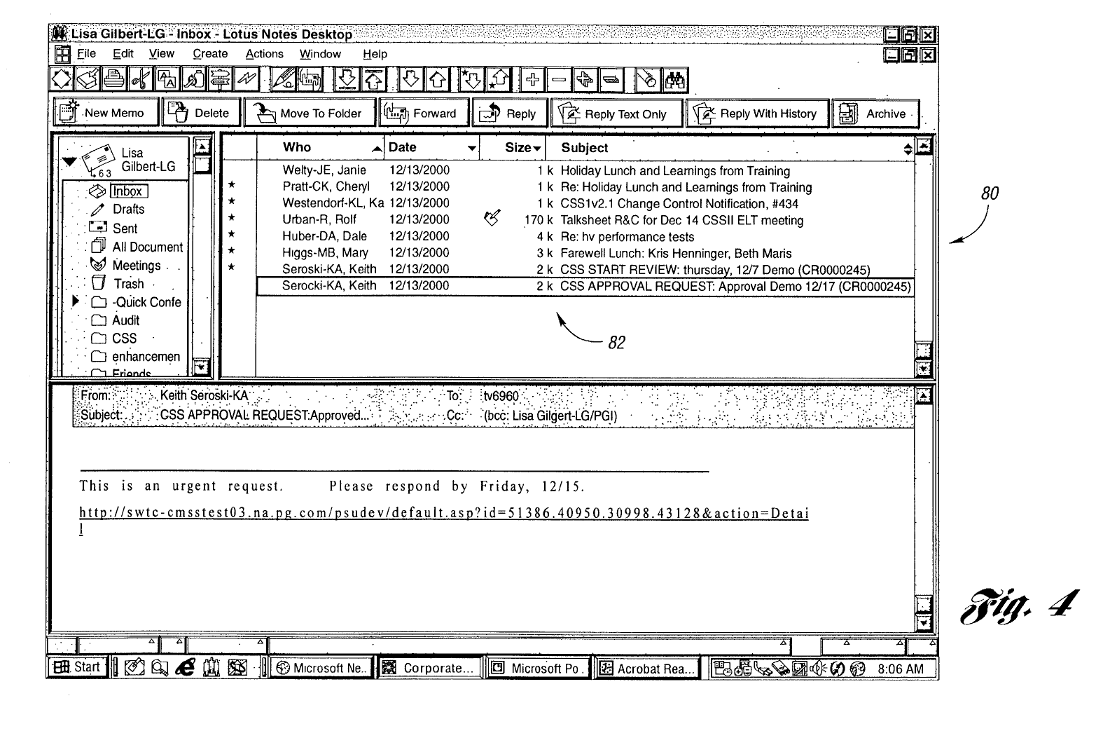

Referring now to FIG. 4, an illustration of approver notification according to an embodiment of the present invention is shown. An approver notification screen, shown generally by 80, is preferably implemented using a standard electronic mail tool. When an approver selects an approval mail message, such as indicated by 82, approver tools are automatically invoked.

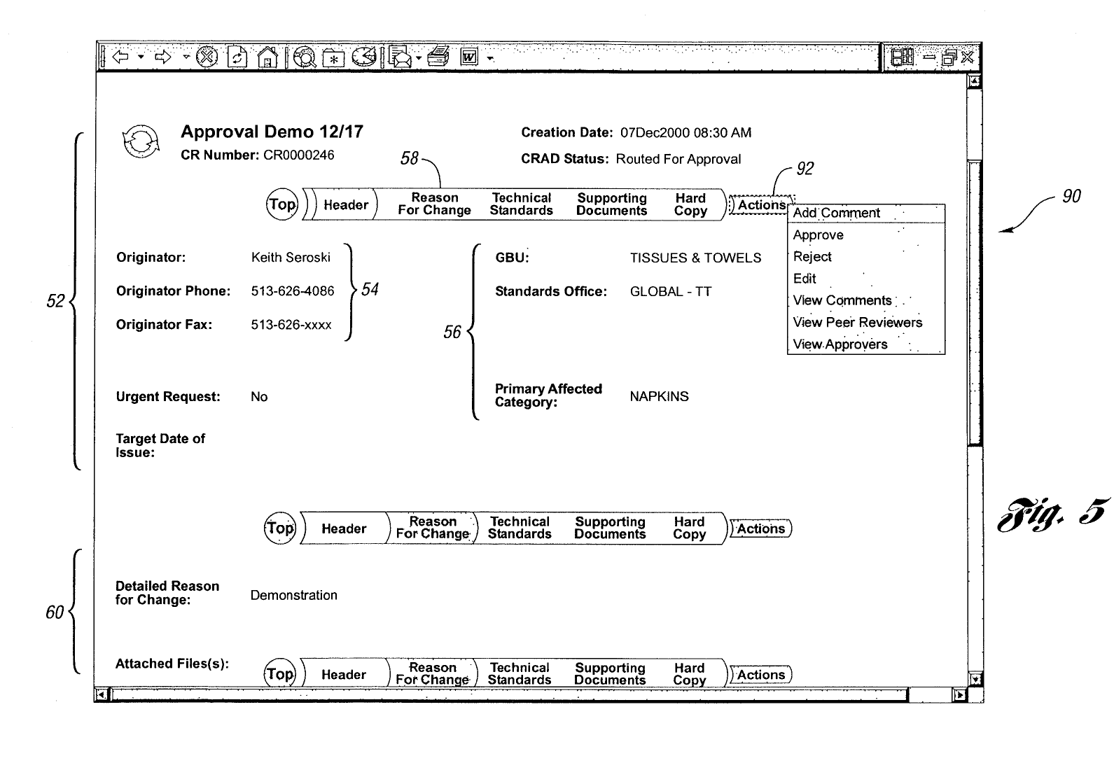

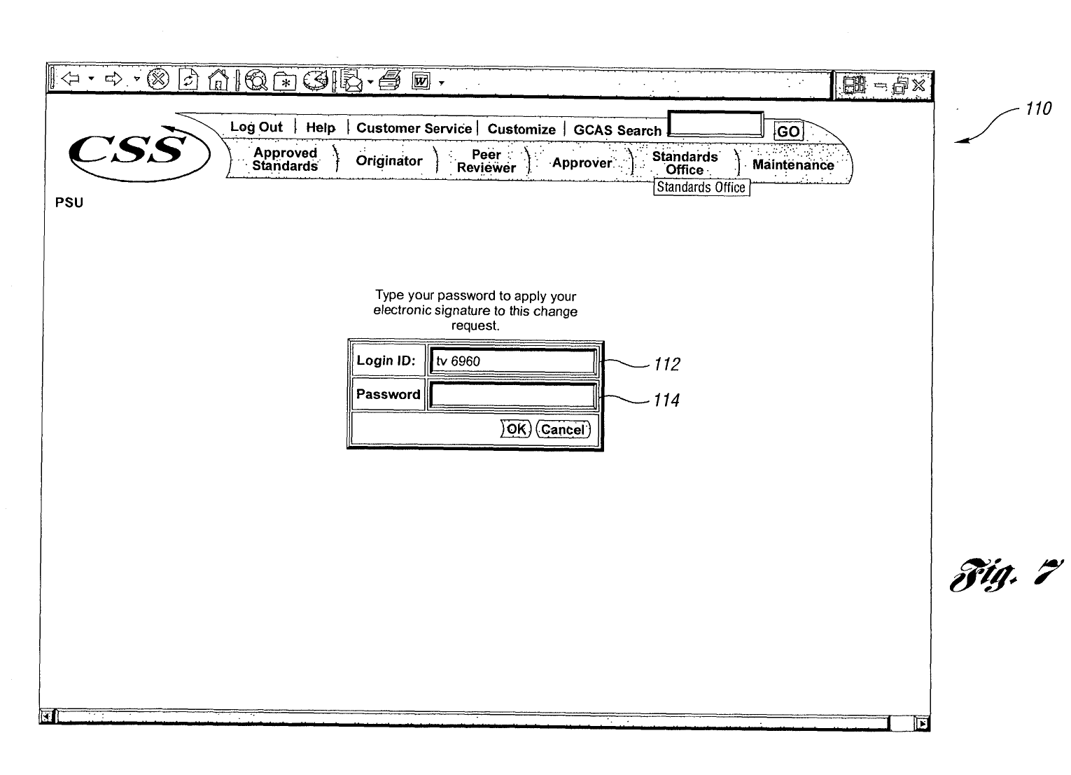

Referring now to FIG. 5, an illustration of electronic approver tools according to an embodiment of the present invention is shown. An approver screen, shown generally by 90, contains much of the same information as reviewer screen 50 including header 52, originator information 54, business information 56 and screen control 58. Action control 92, however, presents different options. The reviewer may add a comment, approve the draft standard, reject the draft standard, edit comments, view comments of peer reviewers and other approvers, view the list of peer reviewers and view the list of approvers. Selecting the view comments option brings up a comment view screen, shown generally by 100. The approver may access all comments entered by review group members and, if any were attached, review supporting documentation. If the approver selects the approve control, an approval entry screen, such as shown by 110 in FIG. 7 is displayed. An electronic signature may be entered in the form of an identification code in ID control 112 and a password in password control 114. As will recognized by one of ordinary skill in the art, many forms of electronic signature are possible, including identification card, retinal scan, fingerprint scan, voice recognition, signature recognition, and the like.

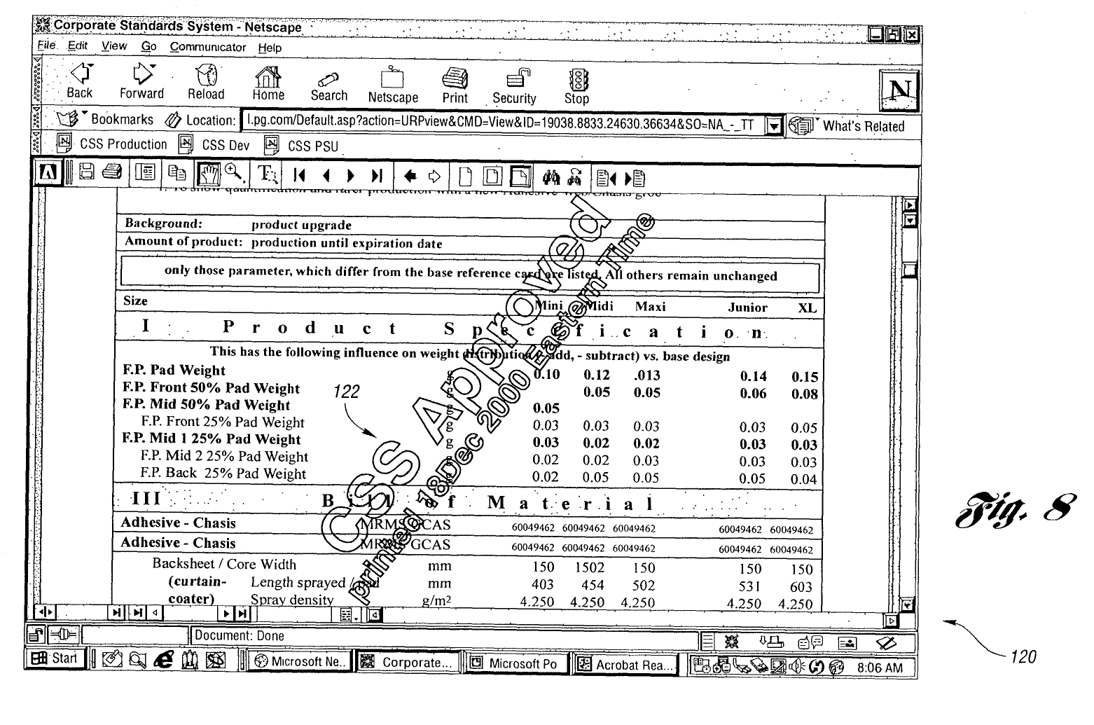

Referring again to FIG. 1, the fully approved standard is rendered unchangeable in block 42. An electronic copy of the technical standard is created in a format that cannot be easily modified using standard tools such as spreadsheets and wordprocessors. A rendered standard screen, such as 120 shown in FIG. 8 provides an example of a standard converted to portable document format (PDF). Preferably, the rendered standard includes watermark 122 with the current date. Thus, if rendered standard screen 120 is printed to obtain a hard copy of the standard, the print date will appear on the hard copy. If the standard is ever modified and released with an incremented version, the print dates appearing on hard copies will readily indicate which is the most current version.

Referring again to FIG. 1, the standard is released in block 44. The technical standard is stored in a globally accessible database. Specified users may be electronically notified when the technical standard is released. The technical standard may be translated into at least one language different than the language in which the technical standard was generated and the translated versions linked to the technical standard to permit access to information contained in the technical standard by a wider audience. The technical standard may also be converted to one or more additional renditions for a variety of purposes including meeting the needs of different user groups, satisfying internal or external regulations, permitting greater access to information by handicapped persons, and the like. These renditions may also be linked to the technical standard for easy access. The technical standard may also be stored in a native format within a secure database to permit the originator or other authorized users to modify the standard and re-release with an incremented version number.

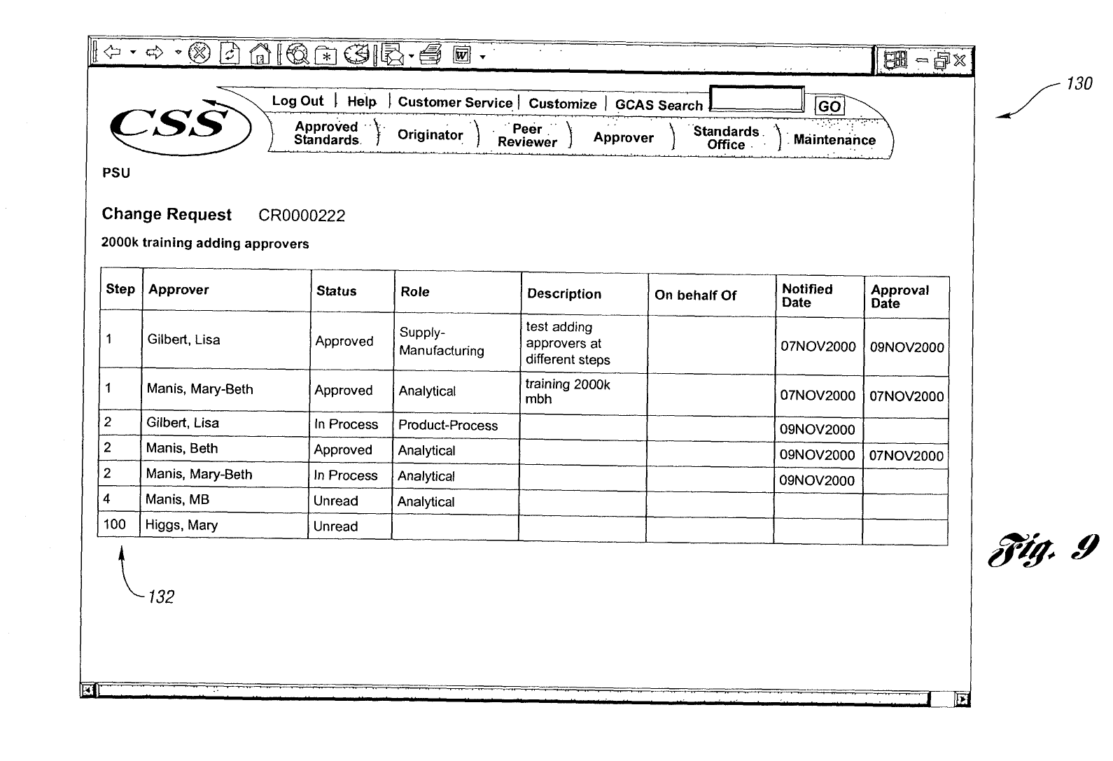

Referring now to FIG. 9, an illustration of approval status checking according to an embodiment of the present invention is shown. A status checking screen, shown generally by 130, may be invoked to check the status of the approval process. As indicated by step column 132, approval may be obtained in steps with all approvers in a given step or subgroup being required to approve before the change request is forwarded to the next step or subgroup. Similar status checking and sub-grouping may be available for the review process as well. Further, computer programs may be run to analyze the review and approval process and indicate improvements in speed, reductions in delays, and the like.

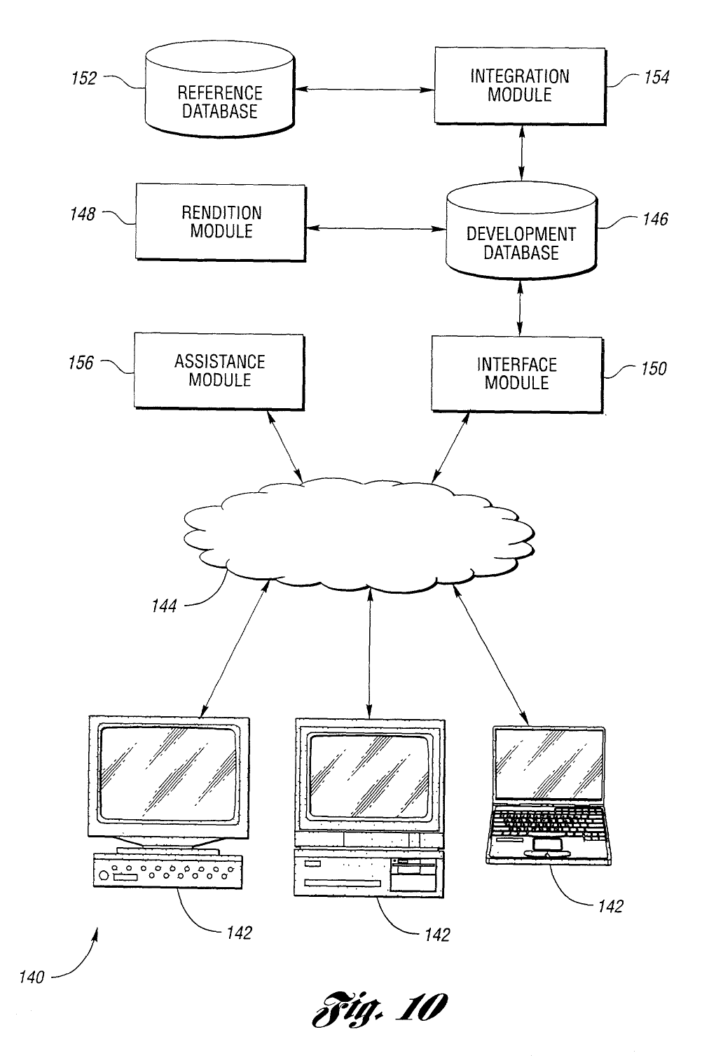

Referring now to FIG. 10, an illustration of a system for review, approval and distribution according to an embodiment of the present invention is shown. A review and approve system, shown generally by 140, services a plurality of users 142 communicating through interconnection network 144. As will be recognized by one of ordinary skill in the art, interconnection network 144 may be any one or more means for interconnecting computer systems such as the Internet, private networks, telecommunications systems, client-server configurations, and the like. Each user 142 may have none, one, or more then one function with regards to each technical standard or related change request. These functions include originator, reviewer, approver and notifyee of released standard. Access to a particular technical standard is based on user authorization and the stage of standard development. User 142 may be authorized based on a role assigned to the user or by approving user 142 through at least one electronic approval in a process similar to the process used to approve the standards themselves.

Review and approve system 140 includes development database 146 holding a plurality of technical standards and related documentation in various stages of development. Preferably, development database 146 is a relational database such as Oracle 8. Review and approve system 140 also includes rendition module 148 in communication with development database 146 for rendering an approved technical standard unchangeable. Rendition module 148 may be implemented as a server capable of converting approved draft technical standards into a format such as PDF. Review and approve system 140 also includes interface module 150 in communication with development database 146. Interface module 150 electronically circulates draft technical standards to users 142 in a specified review group. Review group comments are automatically linked to the draft technical standard which is then locked in development database 146. The locked draft technical standard is electronically circulated to users 142 in a specified approval group. The approval group members have access to the comments provided by members of the review group. Electronic approvals are collected from each member of the approval group. Global electronic access to the electronic standard is permitted after the released approved technical standard is rendered unchangeable. Preferably, interface module 150 is implemented as a customized web interface server.

In an embodiment of the present invention, review and approve system 140 also includes reference database 152 holding a plurality of approved technical standards. Integration module 154 in communication with reference database 152 and development database 146 copies approved technical documents from development database 146 to reference database 152.

Review and approve system 140 may also include assistance module 156 connected to interconnection network 144. Assistance module 156 provides users 142 with automated help and on-line tutorials.

As will be recognized by one of ordinary skill in the art, review and approve system 140 can have many configurations and implementations. For example, reference database 152 and development database 146 may be combined into a single database. Either or both of reference database 152 and development database 146 may also be distributed. Likewise, some or all of rendition module 148, interface module 150, integration module 154 and assistance module 156 may execute on the same computer, closely integrated computers, computers connected through a local area network, or widely dispersed computers. Similarly, one or more modules 148, 150, 154, 156 may be distributed across multiple computers. Multiple copies of some or all of review and approve system 140 may also be in use at different sites.

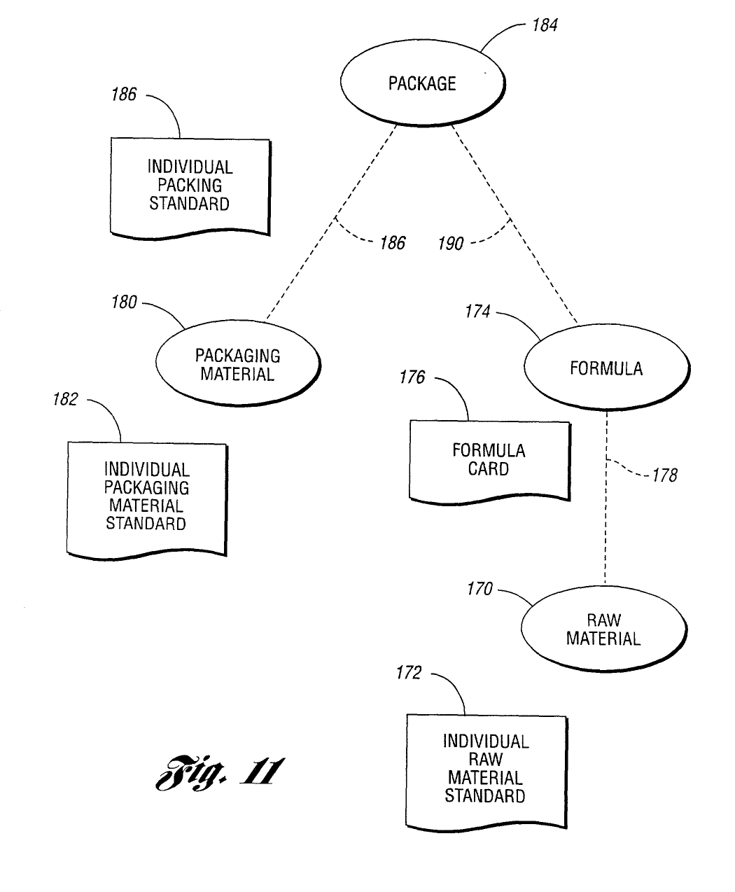

Referring now to FIG. 11, a schematic diagram of objects for specifying a product according to an embodiment of the present invention is shown. Information contained within development database 146 may be grouped into objects some of which may be associated with one or more technical standards. Raw material object 170 may be developed to be described by at least one technical standard such as individual raw material standard 172. Product formula or design object 174 may be developed to be described by at least one technical standard such as formula or design card 176. Formula object 174 specifies raw material used in manufacturing a product. The term formula may represent a formula, mixture, design, plan, blueprint, layout, pattern, project, or any other type of product specification. Formula object 174 may be linked through material link 178 with any raw material object 170 representing raw material used in manufacturing the product. Packaging material object 180 may be developed to be described by at least one technical standard such as individual packaging material standard 182. Packaging material object 180 specifies at least one element of a package used to hold the product.

In an embodiment of the present invention, package object 184 may be developed to be described by at least one technical standard such as individual packing standard 186. Package object 184 specifies at least one finished package. Package object 184 may be linked through packaging material link 188 with any packaging material object 180 representing packaging material specified by the packing standard. Package object 184 may also be linked through formula or design link 190 with any formula object 174 representing a formula or design specified by the packing standard.

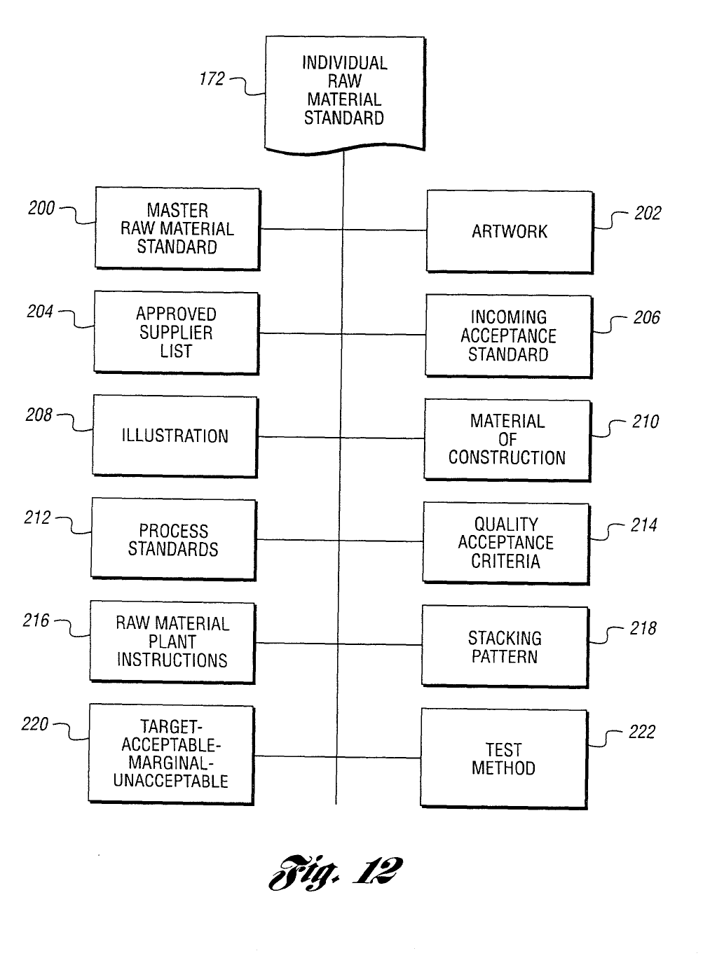

Referring now to FIG. 12, a block diagram of raw material standards according to an embodiment of the present invention is shown. Individual raw material standard 172 may be composed of, linked to, or otherwise associated with a variety of other technical standards, support documentation and related information. Master raw material standard 200 provides basic information about the raw material. Both individual raw material standard 172 and master raw material standard 200 are used when a particular raw material may be packaged or presented in a variety of manners which must be distinguishable. For example, master raw material may generally describe the raw material cottonseed oil whereas individual raw material specification 172 may specify whether the cottonseed oil is shipped in drums or in rail tanker cars. For some raw materials, individual raw material standard 172 and master raw material standard 200 collapse into a single standard. Artwork 202 describes the symbols and labels which must appear on a raw material such as, for example, designs to be pre-printed on a roll of paper feedstock. Approved supplier list 204 describes suppliers for the raw material. Incoming acceptance standard 206 describes the acceptance procedure within a plant receiving the raw material. Illustration 208 describes documentation accompanying the raw material. Material of construction 210 describes the constituent components of the raw material. Process standards 212 provide raw material manufacturing requirements. Quality acceptance criteria 214 describe the standards by which the raw material will be approved. Raw material plant instructions 216 provide handling and processing requirements for the receiving plant. Stacking pattern 218 describes any special packaging or handling instructions for the raw material. Target-acceptable-marginal-unacceptable standard 220 describes the design ranges for acceptability. Test method 222 describes various procedures for testing the raw material. As will be recognized by one of ordinary skill in the art, other linked information may also be included.

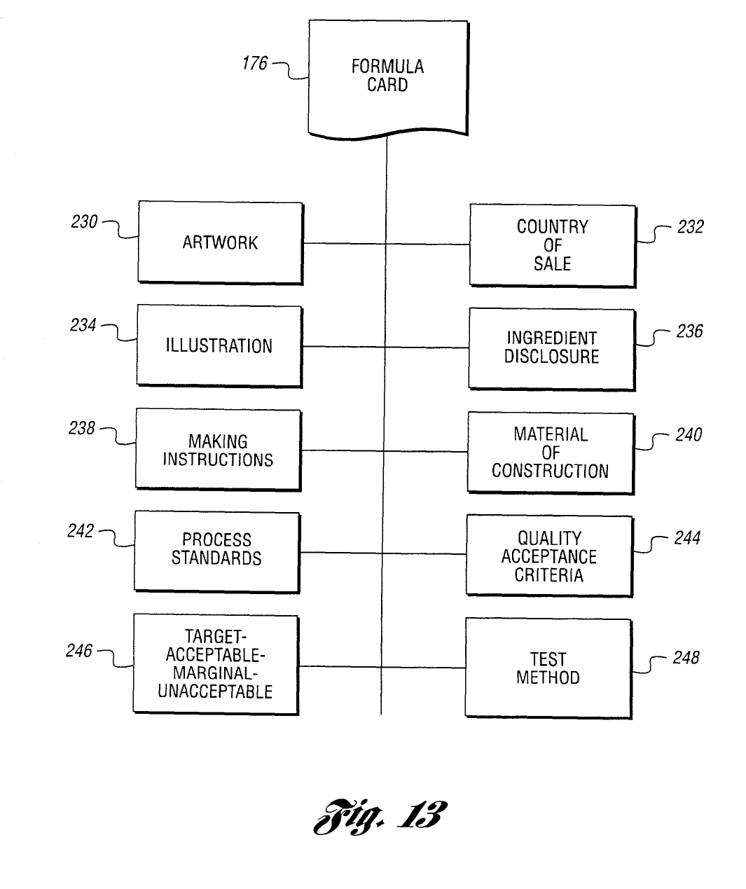

Referring now to FIG. 13, a block diagram of formula or design standards according to an embodiment of the present invention is shown. Formula card 176 may be composed of, linked to or otherwise associated with a variety of additional technical standards, support documents and related information. Artwork 230 describes art associated with the product. Country of sale 232 describes countries for which the product formula or design described by formula card 176 may be sold. Illustration 234 describes documentation which accompanies the product. Ingredient disclosure 236 describes constituent raw material in the product. Making instructions 238 describe the steps required to make the product. Material of construction 240 describes similar information as ingredient disclosure 236. Process standards 242 describe standards for the process of making the product. Quality acceptance criteria 244 describe the standards for accepting the product. Target acceptable marginal unacceptable standard 246 describes design criteria for accepting the product. Test method 248 describes methods for testing the product.

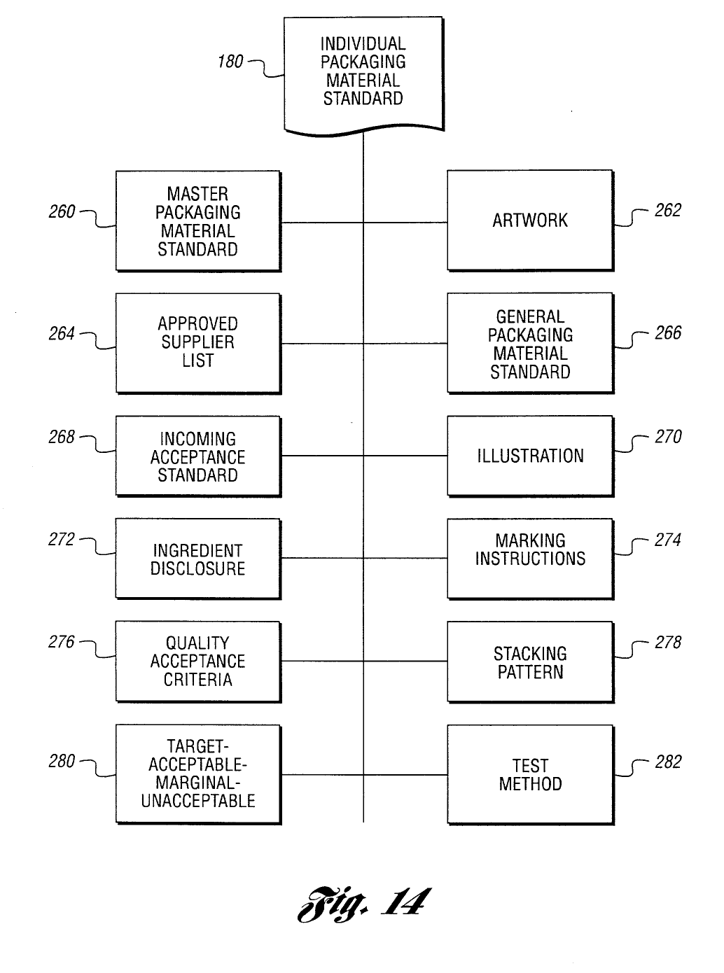

Referring now to FIG. 14, a block diagram of packaging material standards according to an embodiment of the present invention is shown. Individual packaging material standard 180 may also be composed of, linked to or otherwise associated with a plurality of other technical standards, support documents and related information. Master packaging material standard 260 and individual packaging material standard 180 describe the particular packaging material and any particular shipping or packaging requirements respectively. Artwork 262 describes any artwork which must accompany packaging material 262. Approved supplier list 264 describes approved suppliers for the packaging material. General packaging material standard 266 describes general standards for all similar packaging material such as, for example, plastic bottles. Incoming acceptance standard 268 describes standards used by manufacturing plants receiving the packaging material. Illustration 270 describes any documentation which accompanies the packaging material. Ingredient disclosure 272 describes the constituent ingredients for the packaging material. Making instructions 274 describe how to make the packaging material. Quality acceptance criteria 276 describe criteria used for acceptance of the packaging material. Stacking pattern 278 describes the particular manner in which the packaging material must be shipped. Target acceptable marginal unacceptable standard 280 describes pictorially the quality acceptance criteria for the packaging material. Test method 282 describes how the packaging material will be tested.

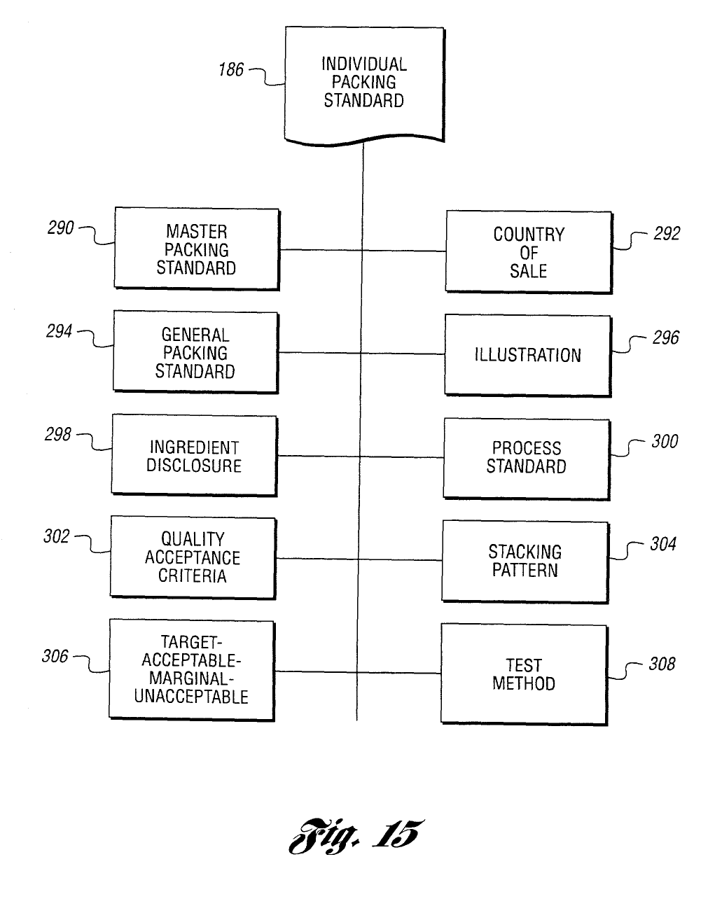

Referring now to FIG. 15, a block diagram of packing standards according to an embodiment of the present invention is shown. Individual packing standard 186 may be comprised of, linked to, or otherwise associated with a plurality of other technical standards, support documents and related information. Master packing standard 290 may specify a family of finished packages with individual packaging standard 186 describing individual members. For example, master packing standard 290 may describe lipstick, a two piece package, and a product label. Individual packing standard 186 may then describe the shade of lipstick and the particular shade label attached to the package. Country of sale 292 describes countries in which the finished package may be sold. General packing standard 294 describes standards for classes of finished packages. Illustration 296 describes documentation accompanying the finished package. Ingredient disclosure 298 describes ingredients to be listed on package copy. Process standard 300 describes assembly and manufacturing processes for the finished package. Quality acceptance criteria 302 describes standards for accepting the finished package. Stacking pattern 304 describes configurations for shipping the finished product. Target-acceptable-marginal-unacceptable standard 306 describes design acceptance standards. Test method 308 describes methods for testing the finished package.

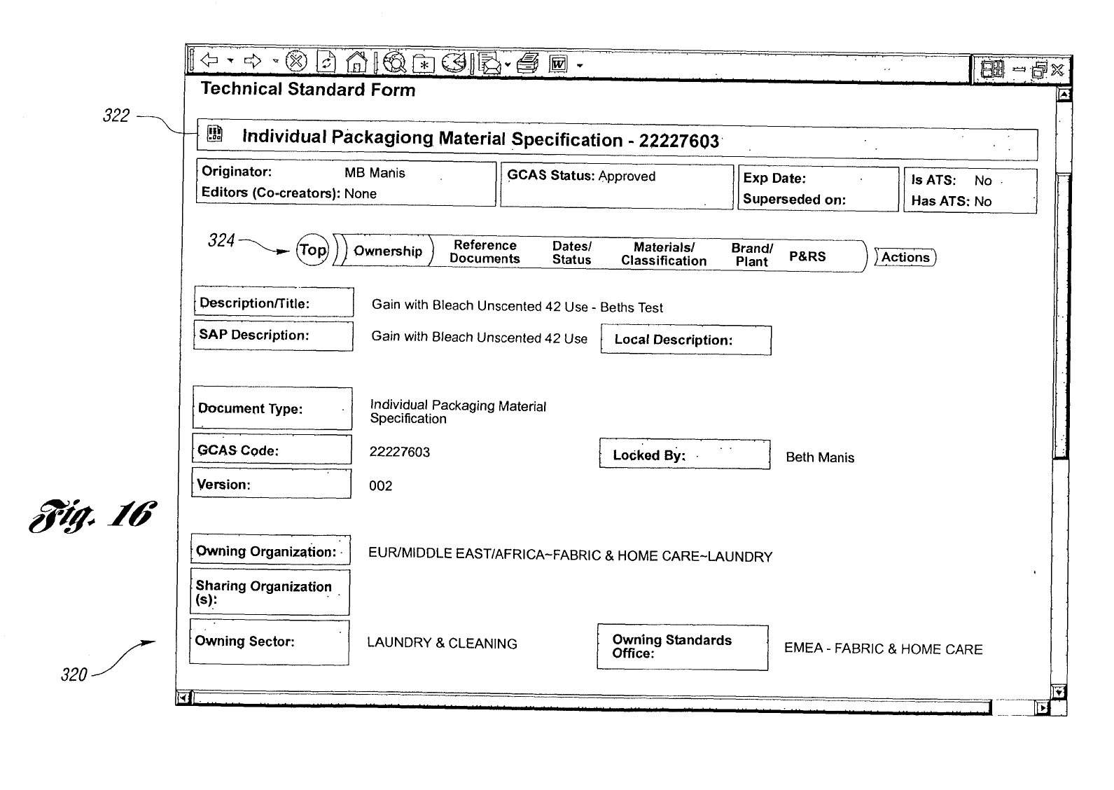

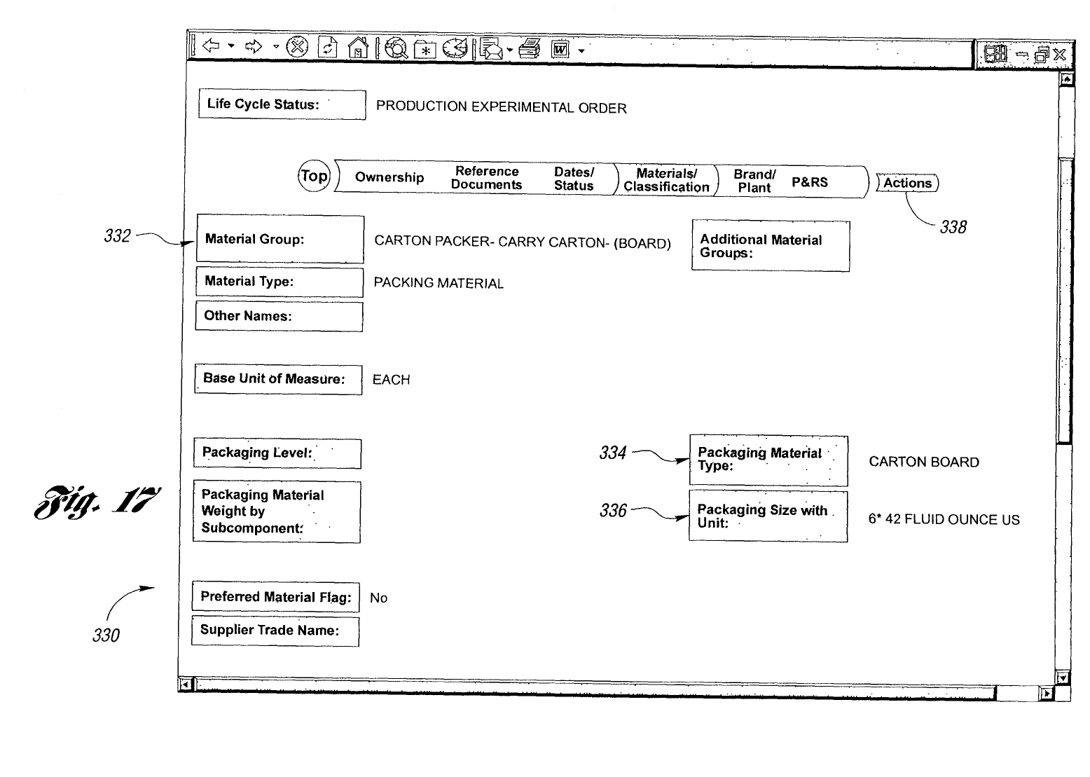

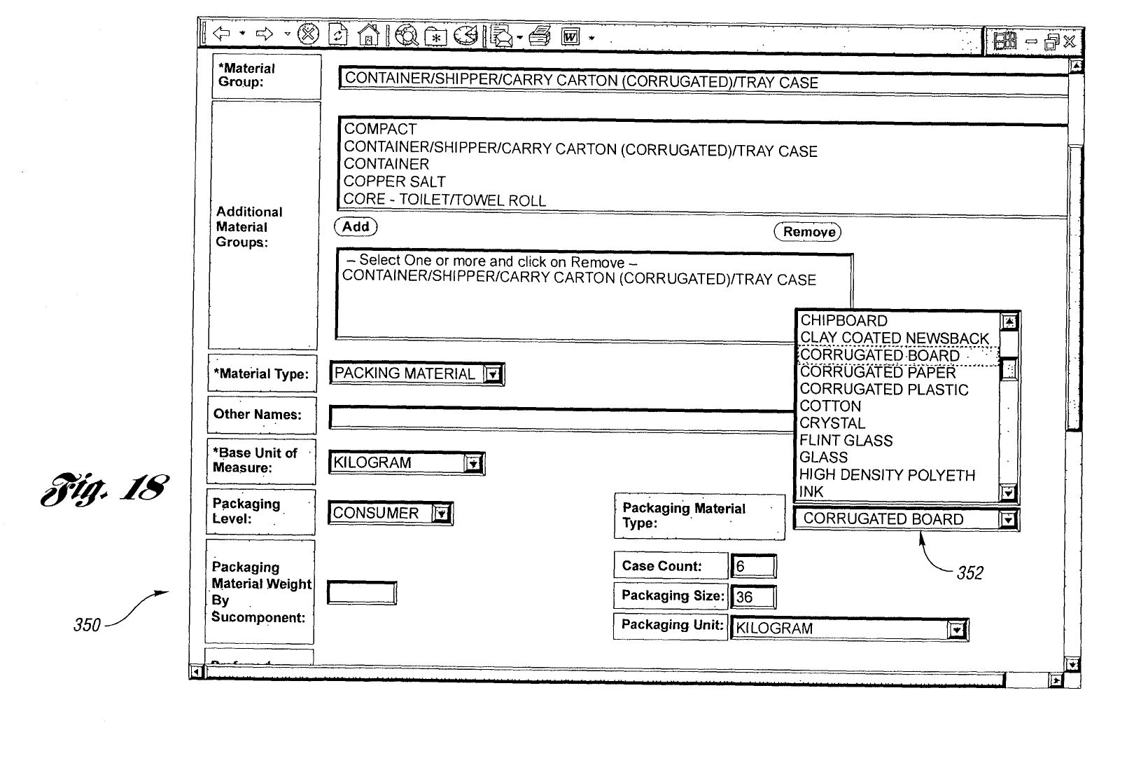

Referring now to FIGS. 16-18, screens illustrating access to a technical specification and associated information are shown. The example provided illustrates a packaging material specification. A header screen, shown generally by 320 in FIG. 16, provides basic information. Specification access control 322 opens the actual packaging material specification. Screen control 324 provides access to collections of information including ownership, reference documents, status and dates, materials classification, brand, plant information and regulatory information. For example, a material classification information screen, shown generally by 330 in FIG. 17, provides various information on the packaging material specified by the packaging material technical specification. This information includes material group 332, packaging material type 334 and packaging material usage 336. Information can be modified by authorized users 142 through action control 338. An attribute control screen, shown generally by 350 in FIG. 18, includes controls for modifying the attributes associated with the packaging material technical standard. For example, packaging material type control 352 provides a pick list from which material type may be selected.

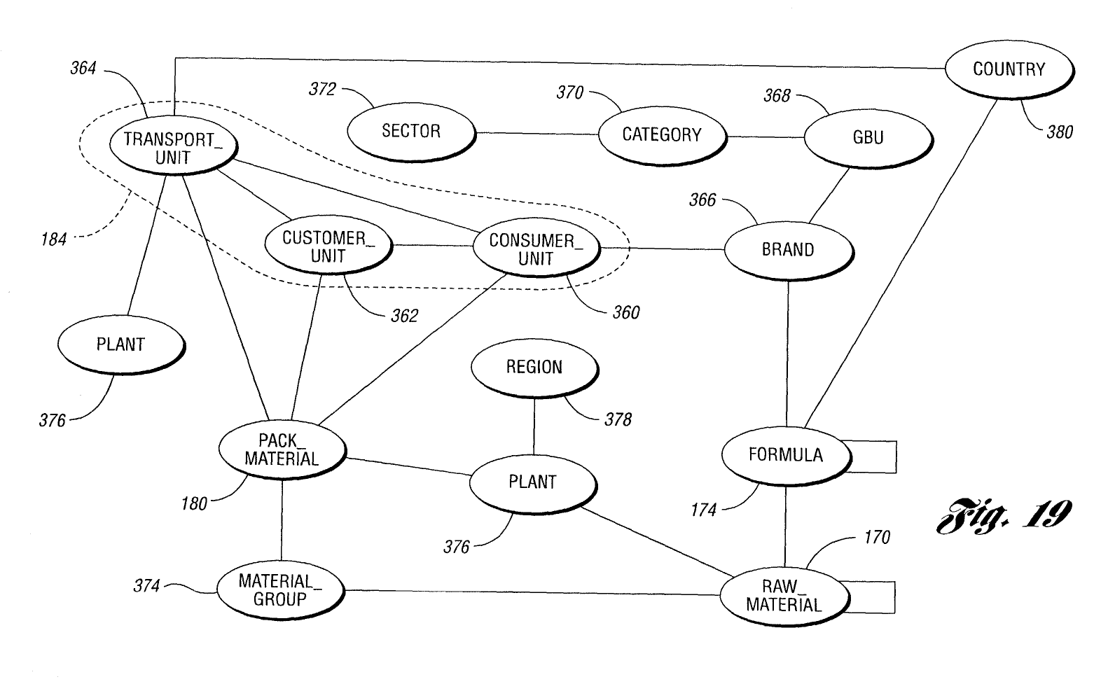

Referring now to FIG. 19, a schematic diagram of an expanded object model according to an embodiment of the present invention is shown. Package object 184 may be subdivided into a plurality of objects to indicate different levels of finished packaging. For example, consumer unit object 360 represents the finished package as received by the end consumer. Customer unit object 362 represents packaging as received by the retailer. Transport unit object 364 represents packaging as the product leaves the plant. For a product such as dish soap, the consumer unit may correspond to a finished package having a squeeze bottle, cap, front and back label, and liquid detergent. The customer unit might be a cardboard box holding 12 consumer units. The transport unit might represent a wooden pallet holding 24 customer units.

Brand object 366 specifies a commercial brand. Each consumer unit 360 is associated with one brand 366. Product formulas or designs, represented by formula objects 174, may have a many-to-many relationship with brand objects 366. Brand objects 366 may be directly or indirectly associated with various business groups. For example, brand object 366 is linked with global business unit object 368. Global business unit object 368 is linked with product category object 370. Each category object 370 is associated with a single market sector object 372.

Material group object 374 specifies a material classification. This material classification may describe a broad class of materials. Material group object 374 may have many-to-many relationships with packaging material objects 180 and raw material objects 170.

Plant object 376, which has been reproduced twice for clarity, represents a facility where materials are used or produced. Plant object 376 may contain links to packaging material objects 180, raw material objects 170, formula objects 174, transport unit objects 364 and region objects 378 defining regional-level business groups. Country object 380 identifies a country where business is conducted or products sold. Country object 380 may contain links to formula objects 174 and transport unit objects 364.

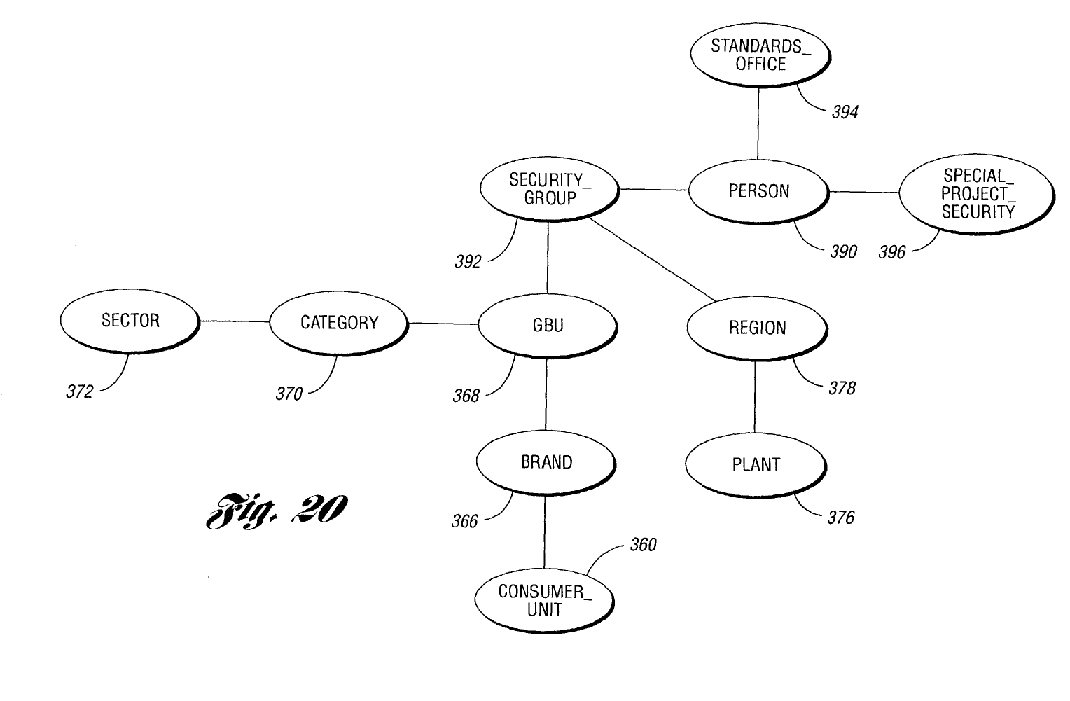

Referring now to FIG. 20, a schematic diagram of an organizational object model according to an embodiment of the present invention is shown. Each user 142 has a corresponding person object 390. Each person object 390 may be linked to one or more security group objects 392. A security group is the intersection of a category, global business unit, and region used to control access to a technical standard. Person object 390 may also be linked to one or more standards office objects 394. Each standards office is responsible for managing the lifecycle of an approved technical standard. Person object 390 may also be linked to one or more special project security objects 396. Special project security is used to control access to highly restricted technical standards.

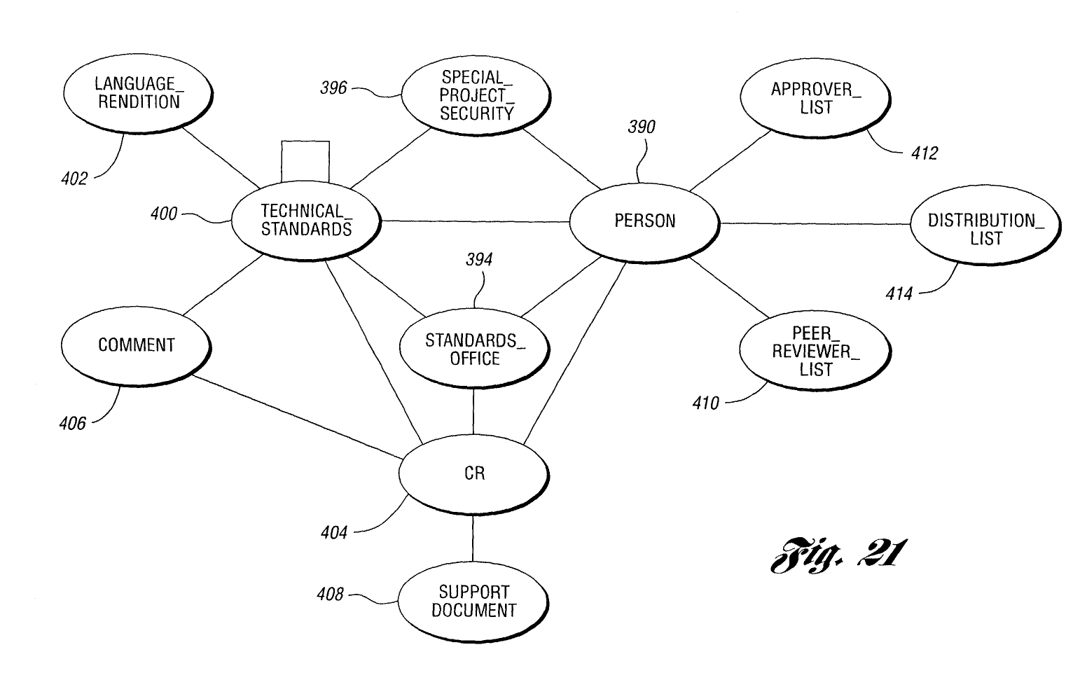

Referring now to FIG. 21, a schematic diagram of a review, approve and distribute object model according to an embodiment of the present invention is shown. Each managed document is represented by a corresponding technical standard object 400. Technical standard object 400 may be linked to one or more other technical standard objects 400. Technical standard object 400 may also be linked to one or more language/rendition objects 402, each specifying at least one language or rendition for presenting the technical standard. Technical standard object 400 may also be linked to one or more change request objects 404. Each change request represents a set of one or more technical standards which needs to be reviewed, approved, and distributed. Technical standard objects 400 and change request objects 404 may be linked to one or more comment objects 406. Each comment captures notes from reviewers or approvers related to a technical standard in a change request. Change request object 404 may also be linked to one or more support document objects 408, each representing one or more documents not under direct control of review and approve system 140.

Each person object 390 may be associated with one or more list objects such as peer reviewer list object 410, approver list object 412 and distribution list object 414. Peer reviewer list object 410 includes a list of people who review a change request. Approver list object 412 includes a list of people who approve a change request. Distribution list object 414 includes a list of people to whom a group of technical standards is to be distributed.

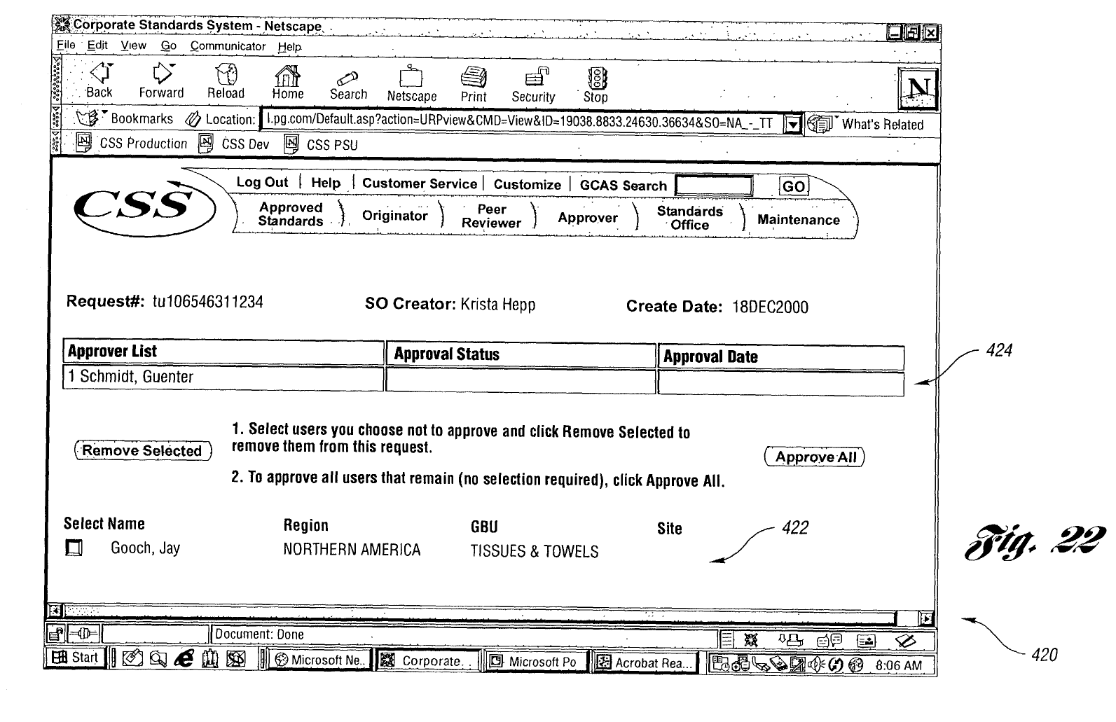

Referring now to FIG. 22, an illustration of user approval according to an embodiment of the present invention is shown. Each user 142 may be approved as a reviewer, approver, or distributee using the same basic procedure as is used for reviewing and approving technical standards. A user approval screen, indicated generally by 420, includes user list 422 of users 142 to be approved or rejected. Each approver in approver list 424 can accept or reject each user 142 in user list 422 before supplying an electronic signature authenticating the approver.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of developing a technical standard in the process of product development comprising:
generating a draft technical standard;
electronically circulating the draft technical standard to a review group;
automatically attaching review group comments to the draft technical standard;
electronically locking the draft technical standard;
electronically circulating the locked draft technical standard to an approval group, the approval group members having access to the review group comments;
collecting electronic approvals from each member of the review group;
rendering the technical standard unchangeable once each member of the review group has electronically approved of the draft technical standard; and
releasing the rendered technical standard for electronic access.

2. A method of developing a technical standard as in claim 1 wherein generating a draft technical standard comprises:
electronically capturing a text-based document containing information relating to the draft technical standard; and
electronically adding data-structured attributes to the captured document.

3. A method of developing a technical standard as in claim 2 further comprising searching for the technical standard based on the data-structured attributes.

4. A method of developing a technical standard as in claim 1 further comprising electronically tracking review and approval status.

5. A method of developing a technical standard as in claim 1 further comprising electronically notifying specified users when the technical standard is released.

6. A method of developing a technical standard as in claim 1 further comprising storing the released technical standard in a globally accessible database.

7. A method of developing a technical standard as in claim 1 further comprising limiting access to the technical standard based on user authorization.

8. A method of developing a technical standard as in claim 7 further comprising approving a user for authorized access by collecting at least one electronic approval.

9. A method of developing a technical standard as in claim 7 further comprising approving a user for authorized access based on a role assigned to the user.

10. A method of developing a technical standard as in claim 1 further comprising:
determining that the technical standard is to be modified;
incrementing the version of the technical standard; and
circulating the incremented version technical standard to the approval group.

11. A method of developing a technical standard as in claim 1 further comprising:
translating the technical standard into at least one language/rendition different than a language/rendition in which the technical standard was generated; and
linking the translated technical standard to the technical standard.

12. A method of developing a technical standard as in claim 1 further comprising attaching additional documentation to the draft technical standard, the additional documentation accessible by members of the review group.

13. A method of developing a technical standard as in claim 1 further comprising printing the rendered technical standard with a watermark including the print date.

14. A method of developing a technical standard as in claim 1 further comprising:
storing the technical standard in a rendered format; and
storing the technical standard in a native format.

15. A system for managing a technical standard, the system accessible by a plurality of product development users, the system comprising:
a development database holding a plurality of technical standards;
a rendition module in communication with the development database, the rendition module rendering an approved technical standard unchangeable; and
an interface module in communication with the development database and the plurality of product development users, the interface module operative to:
(a) electronically circulate a draft technical standard to a review group,
(b) automatically attach review group comments to the draft technical standard,
(c) electronically lock the draft technical standard,
(d) electronically circulate the locked draft technical standard to an approval group, the approval group members having access to the review group comments,
(e) collect electronic approvals from each member of the approval group, and
(f) permit electronic access to the technical standard after the released approved technical standard is rendered unchangeable.

16. A system for managing a technical standard as in claim 15 further comprising:
a reference database holding a plurality of approved technical standards; and
an integration module in communication with the reference database and the development database, the integration module copying approved technical standards from the development database to the reference database.

17. A system for managing a technical standard as in claim 15 wherein the interface module is further operative to:
electronically capture a text-based document containing information relating to the draft technical standard; and
electronically add data-structured attributes to the captured document.

18. A system for managing a technical standard as in claim 17 wherein the interface module is further operative to permit a user to search for the technical standard based on the data-structured attributes.

19. A system for managing a technical standard as in claim 15 wherein the interface module is further operative to electronically notify specified users when the technical standard is approved.

20. A system for managing a technical standard as in claim 15 wherein the interface module is further operative to limit access to the technical standard based on user authorization.

21. A system for managing a technical standard as in claim 20 wherein the interface module is further operative to approve a user for authorized access by collecting at least one electronic approval.

22. A system for managing a technical standard as in claim 15 wherein the interface module is further operative to permit an authorized user to electronically track review and approval status.

23. A system for managing a technical standard as in claim 15 wherein the interface module is further operative to:
increment the version of the approved technical standard; and
circulate the incremented version technical standard to the approval group.

24. A system for managing a technical standard as in claim 15 wherein the interface module is further operative to attach a translated version of the technical standard to the released technical standard.

25. A system for managing a technical standard as in claim 15 wherein the interface module is further operative to permit attaching additional documentation to the draft technical standard, the additional documentation accessible by members of the review group.

26. A system for managing a technical standard as in claim 15 wherein the interface module is further operative to print the rendered technical standard with a watermark including the print date.

27. A method of specifying a product comprising:
developing at least one raw material object, each raw material object described by at least one technical standard;
developing at least one product formula object, each formula object described by at least one technical standard, each formula object specifying raw material used in manufacturing the product;
permitting each product formula object to be linked with any raw material object representing raw material used in manufacturing the product; and
developing at least one packaging material object, each packaging material object described by at least one technical standard, each packaging material object specifying at least one element of a package used to hold the product.

28. A method of specifying a product as in claim 27 further comprising:
developing at least one package object, each package object described by at least one packing standard, each package object specifying at least one finished package;
permitting each package object to be linked with any packaging material object representing packaging material specified by the package object packing standard; and
permitting each package object to be linked with any formula object representing a formula specified by the packing standard.

29. A method of specifying a product as in claim 27 further comprising developing at least one plant object, each plant object specifying a plant.

30. A method of specifying a product as in claim 29 further comprising permitting each plant object to be linked to any formula object specifying a product made in the plant.

31. A method of specifying a product as in claim 29 further comprising permitting each plant object to be linked to any raw material object specifying raw material used by the plant.

32. A method of specifying a product as in claim 29 further comprising permitting each plant object to be linked to any packaging material object specifying packaging material used by the plant.

33. A method of specifying a product as in claim 27 further comprising developing at least one brand object, each brand object specifying a commercial brand.

34. A method of specifying a product as in claim 33 further comprising permitting each brand object to be linked to any formula object specifying a product sold under the commercial brand.

35. A method of specifying a product as in claim 27 further comprising developing at least one material group object specifying a material classification, the material group object linked to any raw material object specifying material in the material classification.

36. A method of specifying a product as in claim 27 further comprising at least one material group object specifying a material classification, the material group object linked to any packaging object specifying packaging in the material classification.

37. A method of specifying a product as in claim 27 wherein each technical standard is linked to a security group object controlling access to the technical standard.

38. A method of specifying a product as in claim 27 wherein at least one technical standard is linked to a standards object specifying an approval lifecycle.

39. A method of specifying a product as in claim 27 wherein at least one technical standard is linked to a language/rendition object specifying at least one language/rendition for presenting the standard.

40. A method of specifying a product as in claim 27 wherein at least one technical standard is linked to at least one comment object including comments about the technical standard.

41. A method of specifying a product as in claim 27 wherein at least one technical standard is linked to at least one change request object specifying at least one technical standard which needs to be reviewed, approved and distributed.

42. A method of specifying a product as in claim 27 wherein at least one technical standard is linked to at least one person object specifying a product development user.

43. A method of specifying a product as in claim 42 wherein each person object is linked to at least one peer review object specifying at least one person which may review a technical standard change request.

44. A method of specifying a product as in claim 42 wherein each person object is linked to at least one approver object specifying at least one person which approve a technical standard change request.

45. A method of specifying a product as in claim 42 wherein each person object is linked to at least one distribution object specifying to which persons an approved technical standard is distributed.

46. A method of specifying a product as in claim 27 further comprising, for each technical standard:
rendering the technical standard unchangeable; and
circulating the technical standard for approval.

47. A method of specifying a product as in claim 46 further comprising:
collecting approvals for the technical standard; and
releasing the technical standard for distribution only after all required approvals are obtained.

48. A method of specifying a product as in claim 47 wherein releasing the technical standard comprises storing the technical standard in a globally accessible database.

49. A method of specifying a product as in claim 47 further comprising disassociating all approvals collected for the technical standard if the technical standard is not to be distributed as rendered unchangeable.

50. A method of specifying a product as in claim 27 wherein at least one technical standard is associated with data-structured attributes.

51. A method of specifying a product as in claim 50 further comprising searching for a technical standard based on the standard data-structured attributes.

52. A method of specifying a product as in claim 27 further comprising attaching at least one support document to at least one technical standard, the support document providing additional information for at least one of a group consisting of technical standard reviewers and technical standard approvers.

53. A system for specifying a finished package, the finished package having at least one product formula and at least one packaging material, the system accessible by a plurality of product development users, the system comprising:
a development database holding a plurality of technical standards, the plurality of technical standards comprising:
(a) at least one raw material technical standard specifying raw material characteristics,
(b) at least one product formula technical standard specifying product characteristics, the product comprising at least one raw material,
(c) at least one packaging material technical standard specifying characteristics of at least one packaging material, and
(d) at least one packing standard specifying characteristics of at least one finished package; and
an interface module in communication with the development database and the plurality of product development users, the interface module operative to permit at least one specified approver user to approve a selected technical standard.

54. A system for specifying a finished package as in claim 53 further comprising a rendition module in communication with the development database, the rendition module rendering a selected technical standard unchangeable.

55. A system for specifying a finished package as in claim 53 further comprising a reference database, the selected technical standard released to the reference database after all approvers have approved the technical standard.

56. A system for specifying a finished package as in claim 53 further comprising an assistance module in communication with the users, the assistance module providing on-line help in using the system.

57. A system for specifying a finished package as in claim 53 wherein the interface module is further operative to permit at least one specified reviewer user to review the selected technical standard.

58. A system for specifying a finished package as in claim 53 wherein the development database further holds at least one raw material link between a raw material object specified by at least one raw material technical standard and a product formula object specified by at least one product formula technical standard.

59. A system for specifying a finished package as in claim 53 wherein the development database further holds at least one formula link between a formula object specified by at least one formula technical standard and a package object specified by at least one packing technical standard.

60. A system for specifying a finished package as in claim 53 wherein the development database further holds at least one packaging material link between a packaging material object specified by at least one packaging material technical standard and a package object specified by at least one packing standard.

61. A system for specifying a finished package as in claim 53 wherein the development database associates comments with at least one technical standard.

62. A system for specifying a finished package as in claim 53 wherein the development database associates at least one support document with at least one technical standard.

63. A system for specifying a finished package as in claim 53 wherein the development database further holds at least one brand object specifying a commercial brand.

64. A system for specifying a finished package as in claim 53 wherein the development database further holds at least one material group object specifying a material classification.

65. A system for specifying a finished package as in claim 53 wherein the development database further holds at least one security object controlling access to at least one technical standard.

66. A system for specifying a finished package as in claim 53 wherein the development database further associates an approval lifecycle with at least one technical standard.

67. A system for specifying a finished package as in claim 53 wherein the development database further holds at least one language/rendition object specifying at least one language/rendition for presenting the standard.

68. A system for specifying a finished package as in claim 53 wherein the development database further holds at least one change request specifying at least one technical standard which needs to be reviewed, approved and distributed.

69. A system for specifying a finished package as in claim 53 wherein the development database further holds at least one person object specifying a user.

70. A system for specifying a finished package as in claim 53 wherein the development database further holds at least one peer review object specifying users which may review a technical standard change request.

71. A system for specifying a finished package as in claim 53 wherein the development database further holds at least one approver object specifying users which approve a technical standard change request.

72. A system for specifying a finished package as in claim 53 wherein the development database further holds at least one distribution object specifying to which users an approved technical standard is distributed.

73. A system for specifying a finished package as in claim 53 wherein the development database associates data-structured attributes with at least one technical standard.

74. A system for specifying a finished package as in claim 73 wherein the interface module is further operative to permit at least one user to search for a technical standard based on data-structured attributes.

75. Computer-readable media having computer-readable instructions for performing a method of specifying a product comprising:
developing at least one raw material object, each raw material object described by at least one technical standard;
developing at least one product formula object, each formula object described by at least one technical standard, each formula object specifying raw material used in manufacturing a product;
permitting linking at least one product formula object with at least one raw material object representing raw material used in manufacturing the product;
developing at least one packaging material object, each packaging material object described by at least one technical standard, each packaging material object specifying at least one packaging material;
developing at least one package object, each package object described by at least one technical standard, each package object specifying at least one finished package;
permitting linking at least one package object with at least one packaging material object representing packaging material used in the finished package specified by the package object; and
permitting linking at least one package object with at least one formula object representing a formula in the finished package specified by the package object.

76. Computer-readable media having computer-readable instructions for performing a method of specifying a product comprising:
generating a draft technical standard;
electronically circulating the draft technical standard to a review group;
automatically attaching review group comments to the draft technical standard;
electronically locking the draft technical standard;
electronically circulating the locked draft technical standard to an approval group, the approval group members having access to the review group comments;
collecting electronic approvals from each member of the review group;
rendering the technical standard unchangeable once each member of the review group has electronically approved of the draft technical standard; and
releasing the rendered technical standard for electronic access.

77. A database for specifying a global product comprising:
at least one raw material object;
at least one product formula object;
at least one packaging material object;
at least one package object;
at least one raw material link, each raw material link linking a product formula object with a raw material object representing raw material used in manufacturing a product specified by the formula object;
at least one packaging material link, each packaging material link linking a package object with a packaging material object representing at least one packaging material included in a finished package represented by the package object; and
at least one formula link, each formula link linking a package object with a formula object representing at least one product included in the finished package.
